(19) United States
(12) Patent Application Publication
(10) Pub. No.: US 2026/0045842 A1
(43) Pub. Date: Feb. 12, 2026

(54) ROTOR OF AN ELECTRIC MACHINE

(71) Applicant: Robert Bosch GmbH, Stuttgart (DE)

(72) Inventors: Simon-Frederik Koch, Hildesheim (DE); Sebastian Runge, Althengstett (DE)

(21) Appl. No.: 18/854,239

(22) PCT Filed: Mar. 20, 2023
(86) PCT No.: PCT/EP2023/057036

§ 371 Date: Oct. 4, 2024

(30) Foreign Application Priority Data
Apr. 7, 2022 (DE) 10 2022 203 531.3

(51) Int. Cl. H02K 1/28; H02K 15/0273

(52) U.S. Cl. CPC H02K 1/28; H02K 15/0273; H02K 2201/06

(57) ABSTRACT

A rotor (2) of an electric machine (1) having a rotor support (4) that is rotatable about a rotor axis (3), in particular a rotor shaft, and a rotor core package (5), which is arranged on the rotor support (4) and comprises a package of sheet lamellae (6), wherein a press-fit connection for transferring torque is provided between the rotor core package (5) and the rotor support (4), wherein the sheet lamellae (6) each have an inner contour (6i) comprising teeth (7) on an inner circumference facing the rotor support (4) in order to form the press-fit connection, wherein at least one sub-package of the rotor core package (5) is formed from sheet lamellae with the same shape, in particular an identical shape (6), wherein the sheet lamellae with the same shape (6) are twisted towards one another, at least in the sub-package, by a rotation angle, characterized in that the sheet lamellae with the same shape (6) are twisted towards one another, at least in the sub-package, such that multiple, in particular all, teeth (7) of the inner contour (6i) of the respective sheet lamellae (6) are in each case arranged to partially overlap with teeth (7) of adjacent sheet lamellae (6).

### BACKGROUND

The invention proceeds from a rotor of an electric machine.

A rotor of an electric machine is already known from JP2006217770 A2, comprising a rotor shaft that is rotatable about a rotor axis and a rotor core package that is arranged on the rotor shaft and comprises a package of sheet lamellae. A press-fit connection for transferring torque is provided between the rotor core package and the rotor shaft. The sheet lamellae each have an inner contour comprising teeth on an inner circumference facing the rotor shaft in order to form the press-fit connection. At least one sub-package of the rotor core package is formed from sheet lamellae with the same shape, in particular with an identical shape. The sheet lamellae with the same shape are twisted, at least in the sub-package, by a rotation angle to one another such that the teeth of the sheet lamellae are arranged in a non-flush manner, without overlapping with the teeth of adjacent sheet lamellae. In this way, interstices are formed between the teeth, into which the teeth can bend in the axial direction relative to the rotor axis when forming the press-fit connection.

### SUMMARY

In contrast, the rotor of an electric machine according to the invention has the advantage that the maximum transferable torque of the press-fit connection can be increased by rotating the sheet lamellae with the same shape, at least in the sub-package, so that multiple, in particular all, teeth of the inner contour of the respective sheet lamellae are in each case arranged to partially overlap with the teeth of adjacent sheet lamellae. The corresponding teeth are thus arranged in a non-flush and partially overlapping manner. Due to the partial overlap of the teeth according to the invention, the individual teeth are better mechanically supported, so they are less pliable in the axial direction and thus mechanically stiffer.

According to an advantageous first exemplary embodiment, the inner contours of the sheet lamellae with the same shape can each comprise a plurality of sequences of an interlocking section and an intermediate groove. The interlocking sections each comprise a group of teeth, whereby a tooth groove is formed between adjacent teeth of the respective interlocking section. The intermediate grooves form a plurality of axially extending axial grooves in the rotor core package, whereby at least one weld seam is provided in at least one of the axial grooves for connecting sheet lamellae of the rotor core package. In this way, the rotor core package can be welded to the press-fit connection according to the invention on the inner contour so as to prevent fanning of the sheet lamellae of the rotor core package. The axial grooves are, e.g., designed to be continuous in the axial direction, at least with regard to the sub-package.

It is also advantageous if the axial grooves each have two uneven, in particular ribbed, groove flanks, which are formed by teeth of the interlocking sections, said teeth projecting various distances into the respective axial groove. The uneven or ribbed groove flanks of the axial grooves are created by the twisting of the sheet lamellae. The teeth adjacent to the axial groove extend only far enough into the axial groove that only one axially continuous groove area without teeth remains, in which the weld connection can then be produced. In this way, the rotor core package can be welded to the press-fit connection according to the invention on the inner contour.

It is highly advantageous if the intermediate grooves are wider in the circumferential direction than the tooth grooves of the interlocking sections. As a result, a sufficiently wide axially continuous groove area without teeth remains, in which the weld connection can then be produced.

Furthermore, it is advantageous if a protruding welded lug is formed on a groove base of each of the intermediate grooves in order to form the weld seam. In this way, welding of the weld seam can be better controlled. In addition, welding can be performed using less welding power, so that fewer porosities and less weld failure occur in the weld seam. Nevertheless, the welding errors that still occur are outside the rotor yoke, which improves the reliability and durability of the press-fit connection or the pressed fit. According to a second exemplary embodiment, the welded lugs of the intermediate grooves are formed in a recess of the groove base, whereby weld spatters on the teeth can be avoided.

Moreover, it is advantageous if the position of the welded lugs in the intermediate grooves of the same sheet lamella varies relative to the flanks of the respective intermediate groove and that the sheet lamellae are arranged such that the welded lugs of the same axial groove are flush with one another. In this way, the partial overlap of the teeth of the inner contour according to the invention with teeth of neighboring sheet lamellae is achieved.

It is advantageous if the number of interlocking sections and the number of intermediate grooves respectively corresponds to a rotor pole number of the rotor with respect to a single one of the sheet lamellae. In this way, the rotor core package can be formed from sheet lamellae with the same shape that are punched out with the same or an identical punching tool, for example.

In addition, it is advantageous when the interlocking sections of the respective sheet lamellae, apart from a single one of the interlocking sections, each have the same number of teeth. The overlap of the teeth, and thus the maximum transferable torque, can in this way be increased.

It is further advantageous if the interlocking sections of the respective sheet lamella comprise an odd number of teeth in total. The overlap of the teeth, and thus the maximum transferable torque, can in this way be increased.

The invention also relates to an electric machine comprising a rotor according to the invention.

### BRIEF DESCRIPTION OF THE DRAWINGS

Exemplary embodiments of the invention are shown in simplified form in the drawings and explained in more detail in the subsequent description.

FIG. 1 shows a sectional view of a rotor according to the invention of an electric machine,

FIG. 2 shows a three-dimensional partial view of an inner contour of the rotor according to FIG. 1,

FIG. 3 shows a two-dimensional view of the inner contour of the rotor of FIG. 1 according to a first exemplary embodiment,

FIG. 4 shows a view of the detail A of the inner contour of FIG. 3 according to a first exemplary embodiment, and

FIG. 5 shows a view of the detail A of the inner contour of FIG. 3 according to a second exemplary embodiment.

### DETAILED DESCRIPTION

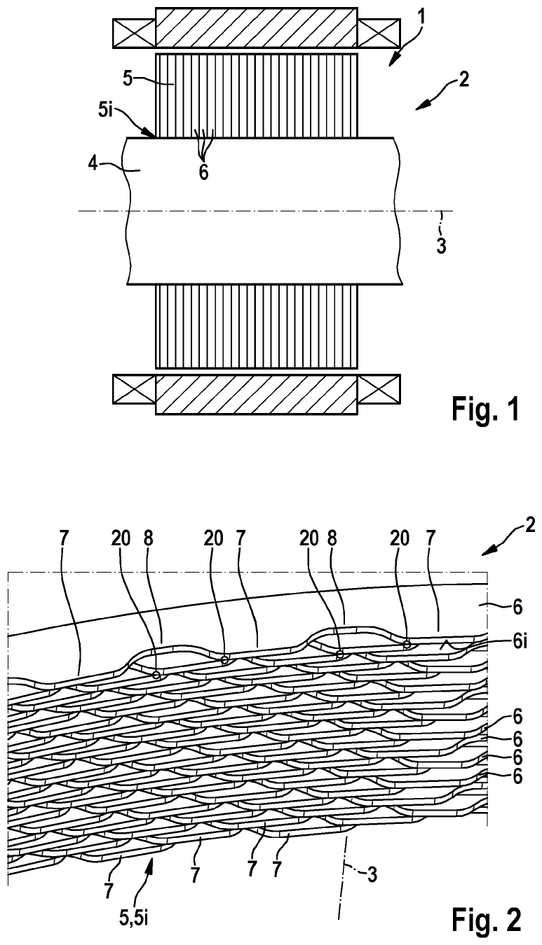

FIG. 1 shows a side view of a rotor of an electric machine according to the invention.

The rotor 2 of an electric machine 1 comprises a rotor support 4, in particular a rotor shaft, which can be rotated about a rotor axis 3, and a rotor core package 5 which is arranged on the rotor support 4. The rotor core package 5 comprises a package of sheet lamellae 6, in particular made of electrical sheet. A press-fit connection for transferring torque is provided between the rotor core package 5 and the rotor support 4. Arranged on the inner circumference 5i of the rotor core package 5 is a tooth structure, which interacts with the, e.g., cylindrical rotor support 4 in order to form the press-fit connection.

FIG. 2 shows a three-dimensional partial view of an inner circumference 5i of the rotor of FIG. 1 designed according to the invention.

The sheet lamellae 6 each have an inner contour 6i comprising teeth 7 on an inner circumference facing the rotor support 4 in order to form the press-fit connection with the rotor support 4. At least one sub-package of the rotor core package 5 is constructed of sheet lamellae 6 with the same shape, in particular an identical shape. The sheet lamellae with the same shape 6 are, e.g., punched out with the same punching tool. The sheet lamellae with the same shape 6 are rotated towards one another, at least in the sub-package, by an angle of rotation about the rotor axis 3. For example, the angle of rotation of the sheet lamellae 6 can correspond to an angle resulting from a quotient of 360°/number of rotor poles or a whole number multiple of the quotient.

According to the invention, it is provided that the sheet lamellae with the same shape 6 are twisted towards one another, at least in the sub-package, such that multiple, in particular all, teeth 7 of the inner contour 6i of the respective lamella 6 are arranged to each partially overlap with teeth 7 of adjacent sheet lamellae 6 while forming a respective tooth overlap 20.

The teeth have a tooth height H in the radial direction with respect to the rotor axis 3, which is in the range between, e.g., 0.1 mm and 0.8 mm. The sheet lamellae 6 have, e.g., a sheet thickness in the range between 0.1 mm and 0.5 mm.

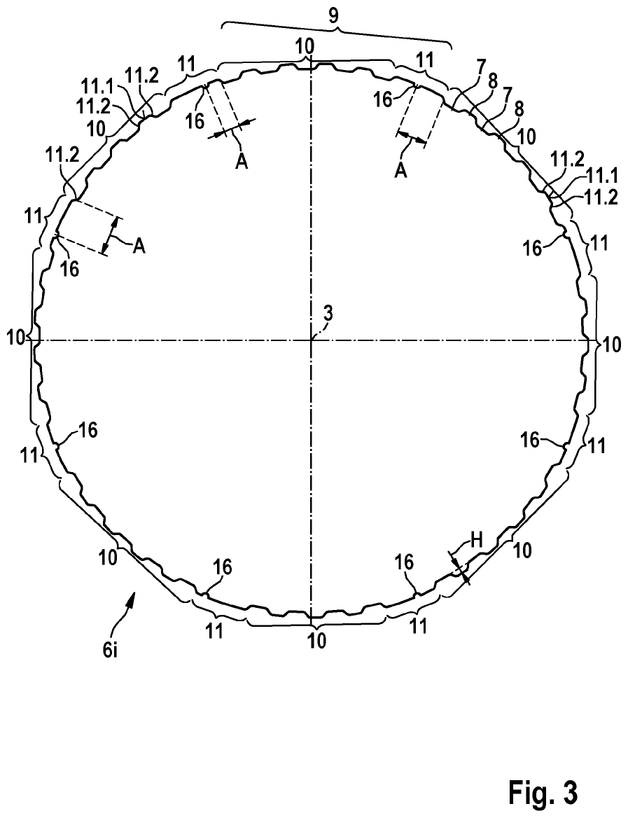

The structure of the inner circumference 5i of the rotor 2 shown in FIG. 2 can extend circumferentially throughout the entire inner circumference 5i without interruption. Alternatively, the structure of the inner circumference 5i of the rotor 2 can be interrupted at certain circumferential positions according to FIG. 3 to FIG. 5.

FIG. 3 shows a two-dimensional view of the inner contour of the rotor of FIG. 1 according to a first exemplary embodiment.

According to the first exemplary embodiment, the inner contours 6 of the sheet lamellae with the same shape 6 each have a plurality of sequences of a interlocking section 10 and an intermediate groove 11. Each of the intermediate grooves 11 are arranged individually between two adjacent interlocking sections 10 of the same sheet lamella 6.

The interlocking sections 10 each comprise a group of teeth 7, whereby a tooth groove 8 is formed between adjacent teeth 7 of the respective interlocking section 10.

The intermediate grooves 11 of the sheet lamellae 6 interrupt the interlocking sections 10 in order to be able to arrange an axially-extending weld seam 15 in intermediate grooves 11. The intermediate grooves 11 of the sheet lamellae 6 are designed to be wider in the circumferential direction, for example, than the tooth grooves 8 of the interlocking sections 10.

With regard to a single one of the sheet lamellae 6, the number of interlocking sections 10 and the number of intermediate grooves 11, corresponds to, e.g., a respective number of rotor poles of the rotor 2.

The interlocking sections 10 of the respective sheet lamellae 6 each have the same number of teeth 7, apart from one single interlocking section 10.

For example, the interlocking sections 10 of the respective sheet lamellae 6 have an odd number of teeth 7 in total.

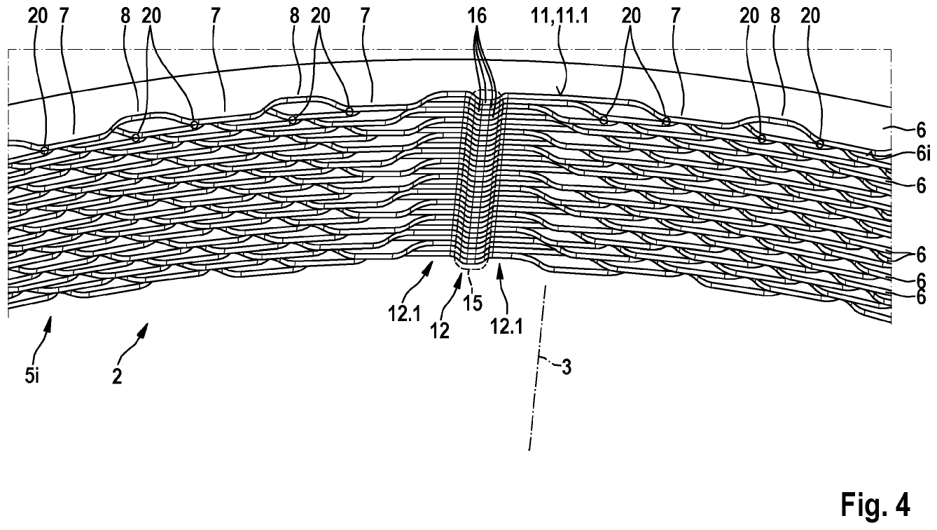

FIG. 4 shows a view of the detail A of the inner contour of FIG. 3 according to a first exemplary embodiment.

The intermediate grooves 11 of the sheet lamellae 6 form a plurality of axially extending axial grooves 12 in the rotor core package 5 with respect to the rotor axis 3. In at least one of the axial grooves 12, at least one weld seam 15 is provided for connecting sheet lamellae 6 of the rotor core package 5. The axial grooves 12 each have two uneven, in particular ribbed, groove flanks 12.1, which are formed by teeth 7 of the interlocking sections 10, said teeth projecting various distances into the respective axial groove 12.

A protruding welded lug 16 can be formed on a groove base 11.1 of the intermediate grooves 11 to form the weld seam 15. According to the first exemplary embodiment, the welded lugs 16 are formed on the flat or planar groove base of the intermediate grooves 11.

The position or the distance A of the welded lugs 16 relative to the flanks 11.2 of the respective intermediate groove 11 varies in the intermediate grooves 11 of the same sheet lamella 6 or in the group of intermediate grooves 11 of the same sheet lamella 6 (FIG. 3). The sheet lamellae 6 are arranged such that the welded lugs 16 of the same axial groove 12 are flush with each other (FIG. 4).

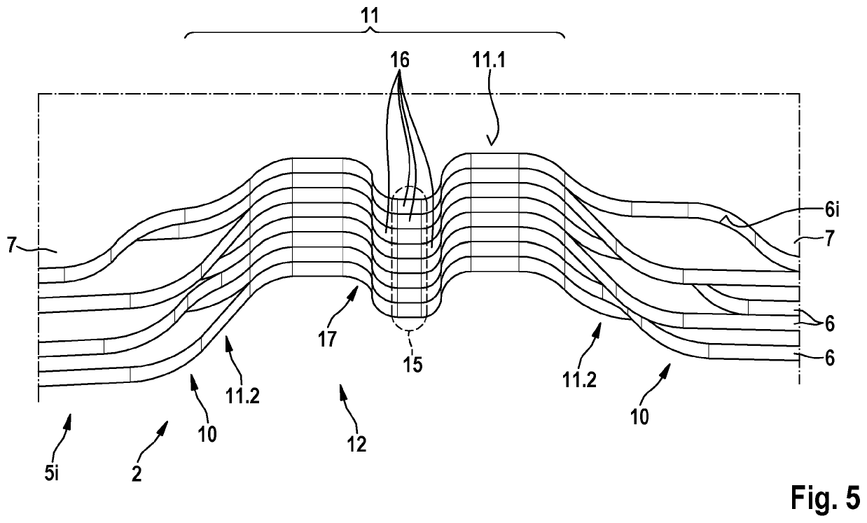

FIG. 5 shows a view of the detail A of the inner contour of FIG. 3 according to a second exemplary embodiment.

According to the second exemplary embodiment, each of the groove bases 11.1 of the intermediate grooves 11 comprises a recess 17, which is narrower than the respective intermediate groove 11 when viewed in the circumferential direction and is recessed, for example against a tooth root diameter of the teeth 7. The welded lugs 16 are provided within the recess 17 on the groove base 11.1 according to the second exemplary embodiment.

1. A rotor (2) of an electric machine (1) having a rotor support (4) that is rotatable about a rotor axis (3), and at least one rotor core package (5), which is arranged on the rotor support (4) and comprises a package of sheet lamellae (6), wherein a press-fit connection for transferring torque is provided between the rotor core package (5) and the rotor support (4), wherein the sheet lamellae (6) each have an inner contour (6i) comprising teeth (7) on an inner circumference facing the rotor support (4) in order to form the press-fit connection, wherein at least one sub-package of the rotor core package (5) is formed from sheet lamellae with a same shape, wherein the sheet lamellae with the same shape (6) are twisted towards one another, at least in the sub-package, by a rotation angle, wherein
the sheet lamellae with the same shape (6) are twisted towards one another, at least in the sub-package, such that multiple teeth (7) of the inner contour (6i) of the respective sheet lamellae (6) are in each case arranged to partially overlap with teeth (7) of adjacent sheet lamellae (6).

2. The rotor according to claim 1, wherein the inner contour (6i) of each of the sheet lamellae with the same shape (6) comprises a plurality of sequences (9) of an interlocking section (10) and an intermediate groove (11), wherein
the interlocking sections (10) each comprise a group of teeth (7), wherein a tooth groove (8) is formed between adjacent teeth (7) of each of the respective interlocking sections (10), and
the intermediate grooves (11) in the rotor core package (5) form a plurality of axially extending axial grooves (12), wherein at least one weld seam (15) is provided in at least one of the respective axial grooves (12) for connecting sheet lamellae (6) of the rotor core package (5).

3. The rotor according to claim 2, wherein the axial grooves (12) each comprise two uneven groove flanks (12.1) that are formed by teeth (7) of the interlocking sections (10), said teeth projecting various distances into the respective axial groove (12).

4. The rotor according to claim 2, wherein the intermediate grooves (11) are configured to be wider in a circumferential direction than the tooth grooves (8) of the interlocking sections (10).

5. The rotor according to claim 2, wherein a protruding welded lug (16) is formed on a groove base (11.1) of each of the intermediate grooves (11) to form the weld seam (15).

6. The rotor according to claim 5, wherein the position of the welded lugs (16) relative to flanks (11.2) of the respective intermediate groove (11) in the intermediate grooves (11) of the same sheet lamella (6) varies, and in wherein the sheet lamellae (6) are arranged such that the welded lugs (16) of the same axial groove (12) are flush with each other.

7. The rotor according to claim 2, wherein, with regard to a single of the sheet lamellae (6), a number of interlocking sections (10) and a number of intermediate grooves (11) in each case corresponds to a number of rotor poles of the rotor (2).

8. The rotor according to claim 2, wherein the interlocking sections (10) of the respective sheet lamellae (6) each have a same number of teeth (7), apart from a single one of the interlocking sections (10).

9. The rotor according to claim 2, wherein the interlocking sections (10) of the respective sheet lamellae (6) have an odd number of teeth (7) in total.

10. An electric machine comprising a rotor (2) according to claim 1.

11. The rotor according to claim 1, wherein the rotor support (4) is a rotor shaft.

12. The rotor according to claim 1, wherein all teeth (7) of the inner contour (6i) of the respective sheet lamellae (6) are in each case arranged to partially overlap with teeth (7) of adjacent sheet lamellae (6).

13. The rotor according to claim 3, wherein the groove flanks (12.1) are ribbed.

14. The rotor according to claim 5, wherein the protruding welded lug (16) is formed in a recess (17) of the groove base (11.1).
